(19) United States
(12) Patent Application Publication
(10) Pub. No.: US 2007/0216712 A1
(43) Pub. Date: Sep. 20, 2007

(54) Image transformation based on underlying data

(76) Inventor: John Louch, San Luis Obispo, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/385,398

(22) Filed: Mar. 20, 2006

(51) Int. Cl. G09G 5/00

(52) U.S. Cl. 345/660; 345/619

(57) ABSTRACT

A method for dynamically transforming an image in a region. According to an embodiment of the present invention, an image contained in a region on a display can be re-rendered based on the underlying data associated with the rendered image. In one embodiment, text strings in a selected region can be magnified or shrunk without changing the rest of the image. Certain objects displayed on a screen can also be rendered differently, for example, using different colors, again, without affecting other parts of the image. Embodiments of the present invention can be used for various purposes, for example, as an aid for visually impaired people.

### BACKGROUND OF THE INVENTION

1. Field of the Invention

This invention generally relates to data processing systems. More particularly this invention relates to methods and apparatuses for displaying data on a display device.

2. Description of the Related Art

In many general-purpose data processing systems, display devices, such as CRT or LCD monitors, use raster graphics. That is, the display area is composed of a two-dimensional array of small picture elements, or pixels. Likewise, an image or frame to be displayed on the screen is made up of a two-dimensional array of data elements, also called pixels. Each data element contains information, such as color and brightness, regarding how to display the appropriate portion of the desired image on the corresponding pixels on the display.

In typical computer systems, a snapshot of the image to be displayed on the screen is maintained in one or more memory areas, called frame buffers. Each frame buffer is specific to a particular display device, and it is created to be compatible with the current display screen of the associated display device. For example, the number of rows and columns of the frame buffer will typically be the same as those of the particular display mode or resolution of the display device, and the color depth of image pixels will be consistent with the color depth that can be displayed on the device.

In many graphical user interface (GUI) designs, display of graphical and textual data is controlled by an application or by a system providing the GUI service such as an Apple Macintosh® operating system (e.g. Mac OS X). Applications, or system services, which interact with the user through a GUI, create screen images or frames for display, often implicitly, according to some predetermined rules or algorithms, and possibly based on user input. The original images, or more precisely the data that are used to generate the images, may not be in a raster format, but they are first converted to proper two-dimensional representations, either by an application or by an operating system service, before they are rendered on the screen. The aforementioned frame buffer is typically used for performance reasons. Some modern hardware graphics adapters or “graphics accelerators” also have internal frame buffers and provide various hardware-based algorithms to manipulate images on the frame buffers.

During the display process, however, some information is inevitably lost. It is, in general, not possible to recover, from the displayed image on the screen, or from the memory content of the frame buffer, the complete information that has been used to generate the image. This “one-way” nature of the typical display process poses a problem in some cases.

Traditionally, screen display has been under complete control of the data processing systems. The user has had few options to configure views or renderings on screens. Due to the wide availability of personal computers in recent years, however, there has been an interest in making displays configurable, or at least more user-specific or user-friendly. For example, the “accessibility” of computer interfaces, in particular, of GUIs, has been a very important part of computer software and hardware designs. This is partly due to the U.S. federal government's requirements known as the section 508 of the Rehabilitation Act, or simply “Section 508”. The idea is that, in a limited sense, the user should be able to adjust or customize the interface or the display, so that it is more suitable for his or her own needs. For example, a visually impaired user or a user who lacks visual acuity of a normal adult person may want his or her images displayed in higher contrast or in bigger text size, etc.

Currently, this type of support, if any, is provided normally by each individual application. One of the most common system-level applications that are related to this topic is an application that uses a “magnifier” metaphor, which simulates a magnifying glass or reading glass in the real world. A typical magnifier application takes a particular region on the screen, often a circular or rectangular lens shape, and it displays, in its own window, a magnified image of the selected region. The magnifier window is usually overlaid on top of the original image or region. In the prior art, the magnification, or zooming, is done based on the screen image or the frame buffer image. That is, the data used to create the magnification view is the image data in the frame buffer.

An exemplary magnifier application in the prior art is shown in FIG. 1. The figure shows a magnifier window 106 and two other windows, 102 and 104, on the desktop. Note that the “z-value” of the magnifier window is lower than those of other windows, and hence typically the magnifier window always stays on top of other windows. A text document is displayed in window 104, whereas an image of objects, which includes two apples in this case, is displayed in window 102. The magnifier window 106 is currently placed over a region which includes portions of content from both windows.

It should be noted that, in some applications, the whole display screen is used as a magnifier window. For example, the zooming functionality of Universal Access options of Macintosh OS X operating system magnifies the whole screen, and it is controlled by mouse or keyboard inputs.

When a user moves around the magnifier window 106 on a display screen, a portion of the screen below the magnifier is displayed as an image inside the magnifier window. The new image typically has an appearance of the original image with a larger magnification or positive zoom. In this example, the text string “small” from the document shown in window 104 is displayed on top portion of the magnifier window. A magnified image of a portion of the apple on the top part of window 102 is also included in the magnifier window.

As illustrated in FIG. 1, the magnified image looks jagged due to the nature of the magnifying process. In the prior art, the magnification, or zooming, is done based on the screen image or the frame buffer image, which is essentially a two-dimensional array of pixels, or picture data elements, with each pixel consisting of a small number of bytes, typically four bytes or so, containing the rendering information at a particular location on the display screen.

During magnification, a region consisting of a smaller number of pixels is mapped to a region consisting of a much larger number of pixels. Therefore, values of some pixels need to be interpolated or computed in an ad-hoc way, and the resulting image magnified this way has less smooth image content. Some applications use a technique called antialiasing to make the generated images smoother and to reduce any anomalies introduced during the magnification. However, the magnified image will still be inherently less accurate compared to an image that would have been originally generated from the application at the same magnification level. Similar problems are observed during the zoom-out process, i.e., while decreasing magnification.

This is an inherent problem with the prior art magnifier applications. During the rendering process of data on a display, information tends to get lost, or compressed. Therefore, a magnification or shrinkage process which relies on the rendered image or its variations, such as an image representation in a frame buffer memory, cannot fully recover all the information that would be needed in order to generate an image at different zoom levels with the complete fidelity. From the user's perspective, this limitation of the prior art translates into less usability and less accessibility.

Changing text size is often handled by applications in a special way. Due in part to the importance of representing textual data in data processing systems, text strings are usually processed in a different way than graphical data. In particular, many applications such as text editors or word processors provide functionalities that allow users to change text sizes. This change is often permanent, and the text size is typically stored with the documents. However, in some cases, text size can be adjusted for viewing purposes, either temporarily or in a user-specific manner. For example, the font size of Web documents can usually be changed from user preference settings in most of the popular Web browser applications, such as Apple Safari or Microsoft Internet Explorer.

One such application in the prior art is illustrated in FIG. 2. In this exemplary application, the text size can be changed based on a user input. FIG. 2A shows a snapshot of the application 132. In this figure, the text 134 is displayed with a small font size. Note that there are seven words displayed in each row, and the words wrap around in the horizontal direction. On the other hand, FIG. 2B shows a different snapshot of the same application 132, this time with a larger font size 136. In this snapshot, there are currently four words displayed in each row. This is often accomplished, in the prior art, by separating the core data and presentation logic. For example, many Web documents comprises multiple components, e.g., HTML files, which contain content data, and CSS style files, which provide the presentation information for particular viewer applications, or viewer types.

Even though this is a very useful feature of many text-viewer applications, this functionality is limited to each individual application. That is, there is currently no magnifier-type application available that allows for the text size change across application boundaries. Furthermore, in the prior art, the change in the font size, which is used for viewing purposes, that is, the change that is not permanently associated with the document itself, affects the whole document or the whole viewing window, and there is no way to magnify or shrink a portion or region of the document.

### BRIEF SUMMARY OF THE DESCRIPTION

The present invention provides methods and apparatuses for dynamically transforming an image (e.g., based on either textual or graphical data) on a display. It also provides a system for context-dependent rendering of textual or graphical objects based on user input or configuration settings. According to embodiments of the present invention, an image contained in a region on a display can be re-rendered based on the semantic data associated with the image.

In at least one embodiment, parts of an image in a selected region can be magnified or shrunk without changing the rest of the image and without changing the underlying data which is stored. For example, certain operations of an embodiment can selectively alter the size of displayed text strings in a selected region. Graphical objects can also be rendered differently depending on the context. For example, same objects can be re-rendered in different colors or in different brightness, again, without affecting other parts of the image. Hence embodiments of the present invention can be used to “highlight” certain features or parts of an image by selectively changing relative sizes and contrasts of various parts of the image.

According to embodiments of the present invention, a region is first selected on a display screen. The region is not limited to any particular window or application. In one embodiment, a region is selected based on user input. In another embodiment, a region is dynamically selected based on at least one preset criterion. Once a region is selected, a desired transformation on the image in that region is specified. It can also be done based on user input and/or other system-wide or user-configured settings.

Next, the data associated with the image in the selected region is retrieved. In embodiments of the present invention, the data associated with the image is categorized into at least two groups. One associated with the presentation, or look or style, of the displayed image and another that is inherent to the underlying objects and independent of the presentation. The latter type of data is referred to as semantic data in this disclosure. Then the desired transformation is applied to the associated data. In certain embodiments, this is done by modifying the presentation. In other embodiments, this is done by generating a complete new image from the underlying semantic data.

Once the new image is generated, the image is displayed on a display screen. In some cases, the new image can be overlaid on top of the original image, as in magnifier applications. The newly generated image can also replace the whole image in the application window. In some other cases, the new image is displayed on a different part of the display screen. For example, the image can be displayed in a separate window on the desktop, for instance, as a “HUD” (heads up display) window. It can also be displayed in a different display device. In at least one embodiment of the present invention, the new image can be further manipulated by the user. For example, the user might (further) enlarge the font size of the (already enlarged) text. Or, the user might even edit the text or modify the transformed image. In some embodiments, the original image may be updated based on this additional change in the second region.

Embodiments of the present invention can be used for a variety of purposes, including aiding visually impaired people. Various features of the present invention and its embodiments may be better understood by referring to the following discussion and the accompanying drawings in which like reference numerals refer to like elements in the several figures. The contents of the following discussion and the drawings are set forth as examples only and should not be understood to represent limitations upon the scope of the present invention.

### BRIEF DESCRIPTION OF THE DRAWINGS

The novel features of the present invention are set forth in the appended claims. The invention itself, however, as well as preferred modes of use, and advantages thereof, will best be understood by reference to the following detailed description of illustrative embodiments when read in conjunction with the accompanying drawings, wherein:

FIG. 1 shows a typical magnifier application in the prior art. When a user moves around a “magnifier” window on a display screen, a portion of the screen below the magnifier is displayed as a magnified image inside the window.

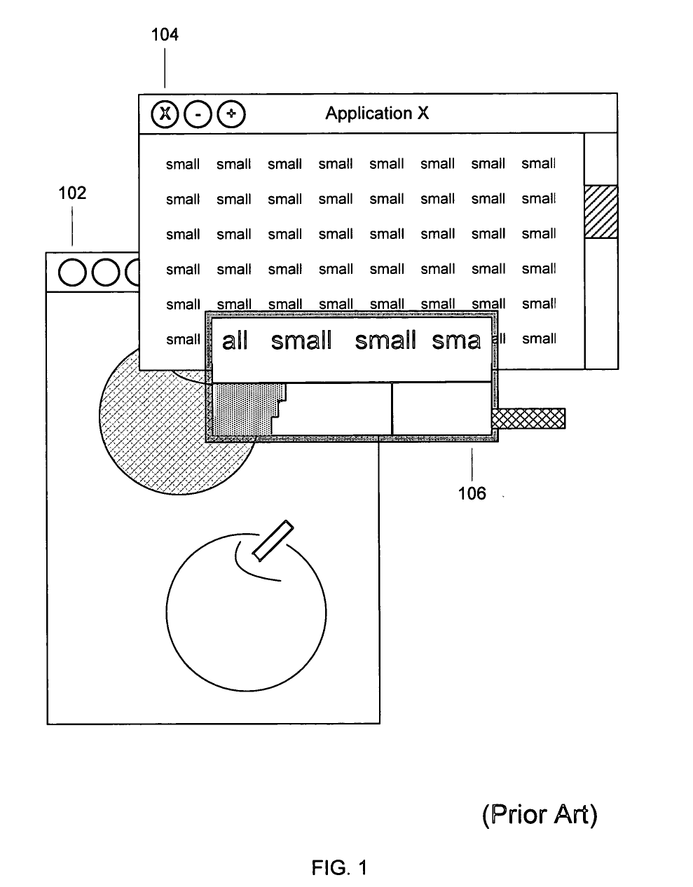

FIG. 2 show a prior art application in which the text size can be changed based on a user input. For example, in many Web browsers, the text or font size of the document in a browser window can be changed by a user.

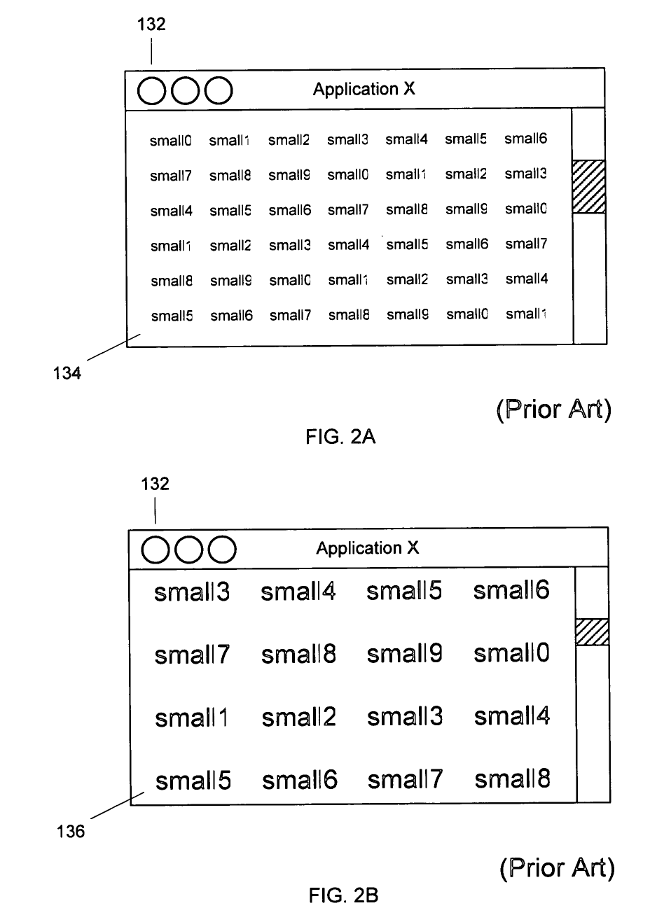

FIGS. 3A-3D illustrate various selection methods according to embodiments of the present invention. FIG. 3A illustrates an exemplary selection method using a rectangular region. This type of interface is often implemented using a “rubber-band” metaphor.

FIG. 3B illustrates another exemplary selection method in some embodiments of the present invention. In this example, an object displayed at the current pointer position is selected.

FIG. 3C illustrates another exemplary selection method, which is a slight variation of the example of FIG. 3B. In this illustration, a rectangular region including the object is selected rather than the object itself.

FIG. 3D illustrates another exemplary selection method according to at least one embodiment of the present invention. In this example, a text string, spanning multiple lines, is selected.

FIGS. 4A-4C illustrate various ways in which transformed images can be displayed. In particular, FIG. 4A shows a transformed image displayed “in-place”. That is, the transformed image is displayed at the same location as that of the original image.

FIG. 4B illustrates another method for displaying transformed images according to exemplary embodiments. In this example, both original and transformed images are shown on different parts of the screen.

FIG. 4C shows another method for displaying transformed images. This exemplary method is similar to the one shown in FIG. 4B. In this example, however, the transformed images are displayed in multiple regions.

FIGS. 5A-5C illustrate various exemplary methods for selecting desired transformations and for specifying various options. FIGS. 5A and 5B show popup menu windows, which include various options for the transformation.

FIG. 5C depicts an exemplary user interface for setting user preferences. These user preference settings can be used in conjunction with other means such as the popup menus shown in FIG. 5A or 5B to customize various options associated with the transformation command.

FIG. 6 illustrates an exemplary behavior according to an embodiment of the present invention. It shows a region in a window displaying a text string. The transformed image is displayed in a region in a different window on the same display device.

FIGS. 7A and 7B are illustrations of a transformation of an object according to an embodiment of the present invention. In this example, an apple is shown in both figures with different renderings or looks.

FIGS. 8A and 8B illustrate another exemplary behavior according to an embodiment of the present invention. In this example, the original image shown in FIG. 8A includes objects, which are considered foreground. The rest of the image is considered background in this illustration.

FIGS. 9A and 9B show another example based on an embodiment of the present invention. In this example, the data associated with the image contains locale-specific information. For example, the string in FIG. 9A is English text, whereas the transformed image in FIG. 9B contains the same string, or content, in a different language.

FIG. 10 shows a method embodiment of the present invention as a flow chart. According to this embodiment, an image in a region on a display is transformed based on the user request or other system settings, and the transformed image is displayed in a region on the display.

FIG. 11 illustrates an exemplary process according to an embodiment of the present invention. In this example, a text string is transformed based on preset rules and/or based on the user input.

FIG. 12 illustrates another exemplary process according to another embodiment of the present invention. In this example, a graphical object is transformed and re-rendered on a display screen.

FIG. 13 is a flow chart showing an exemplary process according to at least one embodiment of the present invention. This flow chart illustrates a method in which a transformed image may be further manipulated by the user.

FIG. 14 shows one exemplary design of an embodiment of the present invention. The various modules shown in the figure should be regarded as functional units divided in a logical sense rather than in a physical sense.

FIG. 15 shows various data structures used in a software embodiment of the present invention. In particular, it shows class diagrams of various internal data structures used to represent data.

FIG. 16 illustrates the semantic transformation of an image according to an embodiment of the present invention. The figure shows two overlapping image objects and their corresponding internal data structures.

FIG. 17 shows an embodiment of the present invention in a hardware block diagram form. The GPU (graphical processing unit) may have its own on-board memory, which can be used, among other things, for frame buffers.

### DETAILED DESCRIPTION

The present invention will now be described more fully hereinafter with reference to the accompanying drawings, in which various exemplary embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention pertains to a system for dynamically transforming an image on a display and rendering a textual and/or graphical image based on the semantic data associated with the image. It should be noted that the word “image” is used broadly in this disclosure to include any rendering of data on a display screen, and it is not limited to, for example, graphical images or drawings or “pictures”, unless otherwise noted. According to at least one embodiment of the present invention, parts of an image in a selected region can be magnified or shrunk without changing the rest of the image and without changing the copy of the underlying data either in a memory or in a file stored on a hard drive or other non-volatile storage. Or, more generally, certain data or image can be rendered differently depending on the context. For example, same graphical objects or text strings can be rendered in different colors or in different brightness while maintaining the same rendering for other parts of the image. Hence embodiments of the present invention can be used to highlight certain features or parts of an image by selectively changing relative sizes and contrasts of various parts of the image.

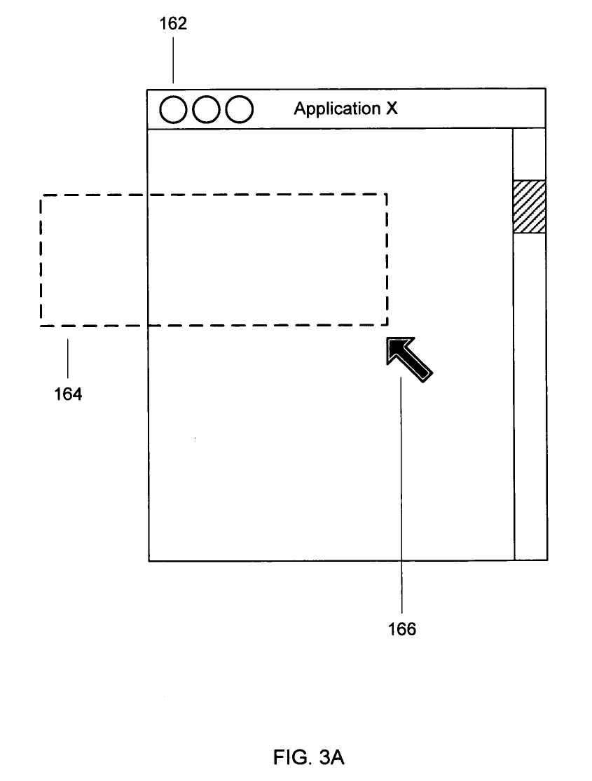

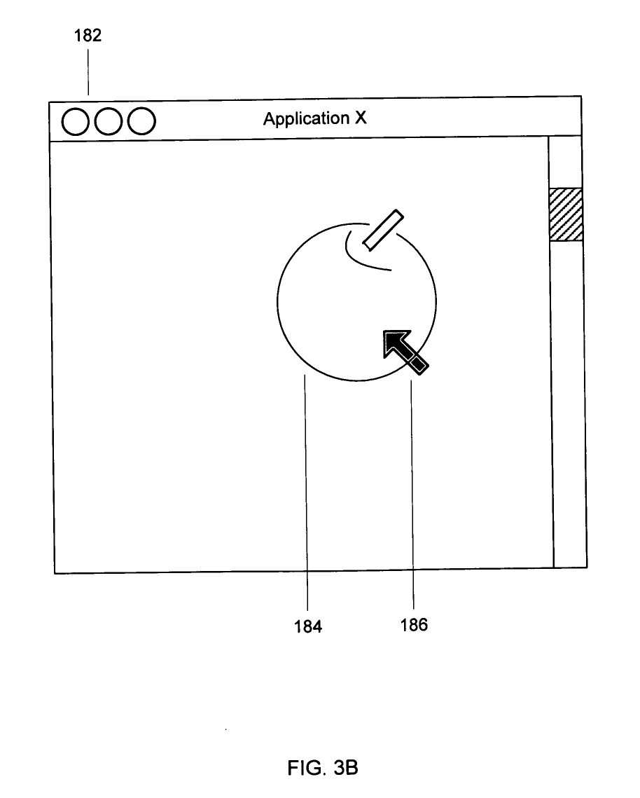

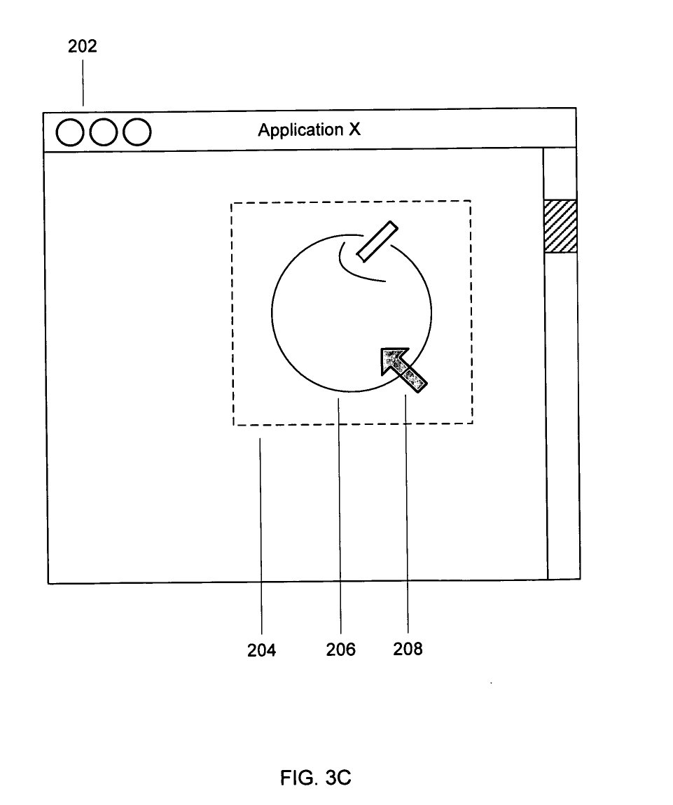

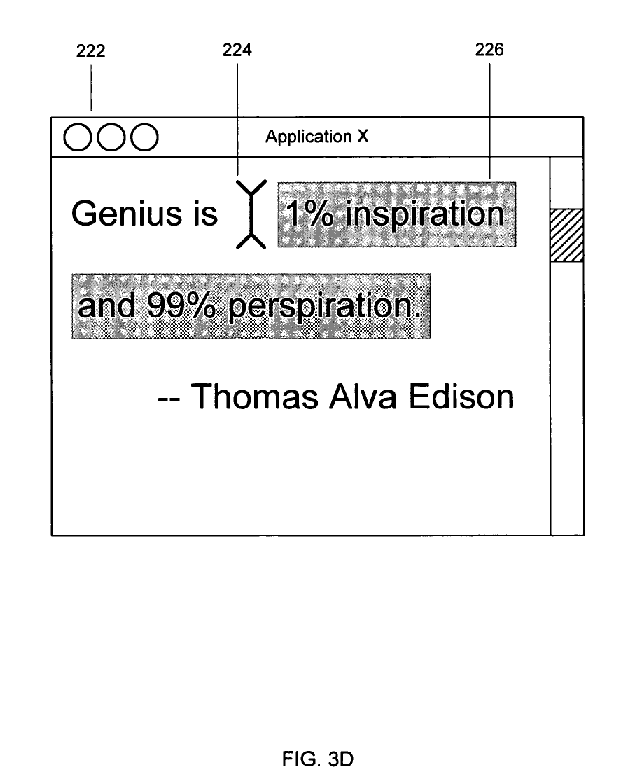

According to embodiments of the present invention, a region is first selected, either implicitly or explicitly, on a display screen. In one embodiment, a region is selected based on user input. In another embodiment, a region is dynamically selected based on at least one preset criterion. A “region” in this context can be of various types and shapes. FIGS. 3A-3D illustrate various regions or selections according to embodiments of the present invention. It should be noted that regions are not limited to any particular window or application, as might be construed from some of the illustrative drawings shown in these figures.

An exemplary selection method is shown in FIG. 3A. The currently selected region 164 containing part of window 162 is marked with dashed lines and it is of a rectangular shape. In some embodiments, a region can be selected by moving a pointer 166 on a screen, typically using a pointing device such as a mouse or a trackball. This type of interface is often implemented using a “rubber-band” metaphor. In other embodiments, a region can be selected by simply placing a predetermined object, such as a magnifying glass window of a predetermined size in a typical magnifier application, at a particular location on the screen. Note that the selection rectangle does not have to be contained in a single window.

FIG. 3B illustrates another exemplary selection method in some embodiments of the present invention. In this figure, an object 184 representing an apple is shown inside an application window 182, and a pointer 186 is hovering over the object. In this example, the object has been selected in response to certain predetermined user action, such as for example, causing a pointer to hover over the object for a predetermined period of time. In some embodiments, visual feedback can be provided to a user, for example, by highlighting the selected object. As further explained later in the specification, in order to be able to implement this type of selection method, the system, or the relevant application, needs to be “aware” of which part of the screen represents a particular object, which we call “semantic data” in this disclosure. In this example, for instance, the apple, drawn in an elliptically shaped region on the screen, has a corresponding semantic data associated with it.

Another exemplary selection method, which is a variation of the example of FIG. 3B, is shown in FIG. 3C. In this example, a rectangular region 204 surrounding the object 206 is selected rather than the object itself. As in the example of FIG. 3B, the object shown in this figure has a focus because the pointer 208 is currently placed or hovering over the object. Note that, as before, the identity of the “object” is defined by the underlying data, and not by the rendered image in the frame buffer. The size of the selection rectangle can be pre-configured or it can be dynamically set by a user. As in the example of FIG. 3A, the selected region in this figure is marked with a broken lines. Even though the object 206 is contained in a single window 202 in this illustration, the selection does not have to be contained in a single window. Furthermore, a selection can be based on multiple objects from multiple windows or applications.

FIG. 3D illustrates another exemplary selection method according to embodiments of the present invention. In this illustration, textual image is displayed in a window 222, in which an object called cursor 224 is also shown. The cursor, or text cursor, is typically used in text-based applications, and it typically signifies an insertion point of new characters or is used for text selection purposes. As indicated by a different background color, some of the text string (“1% inspiration and 99% perspiration”), 226, has been selected. This particular selection might have been done using a pointer (not shown in the figure) and a mouse or using a cursor 224 and a keyboard, or using other selection methods. It should be noted that the selected “region” is non-rectangular in this example unlike in the other examples shown in FIGS. 3A-3C.

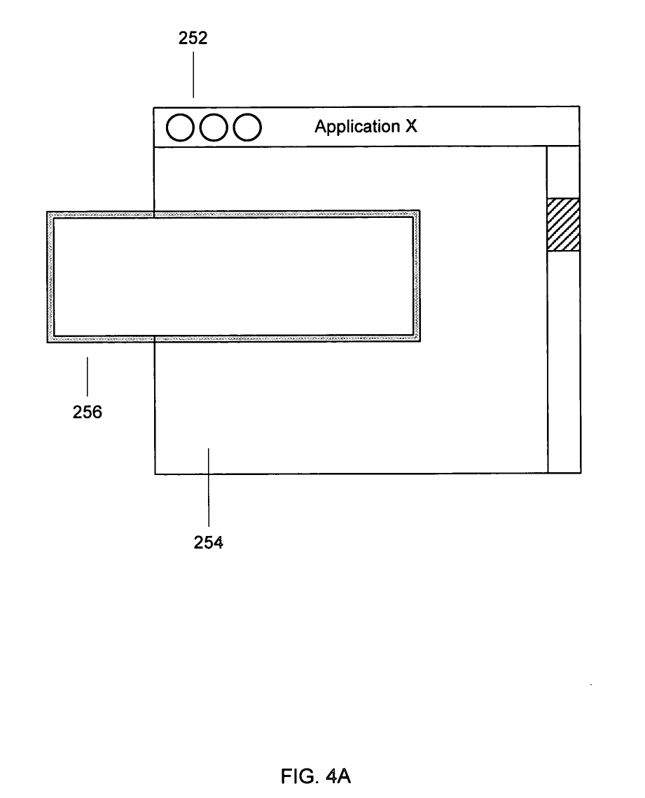

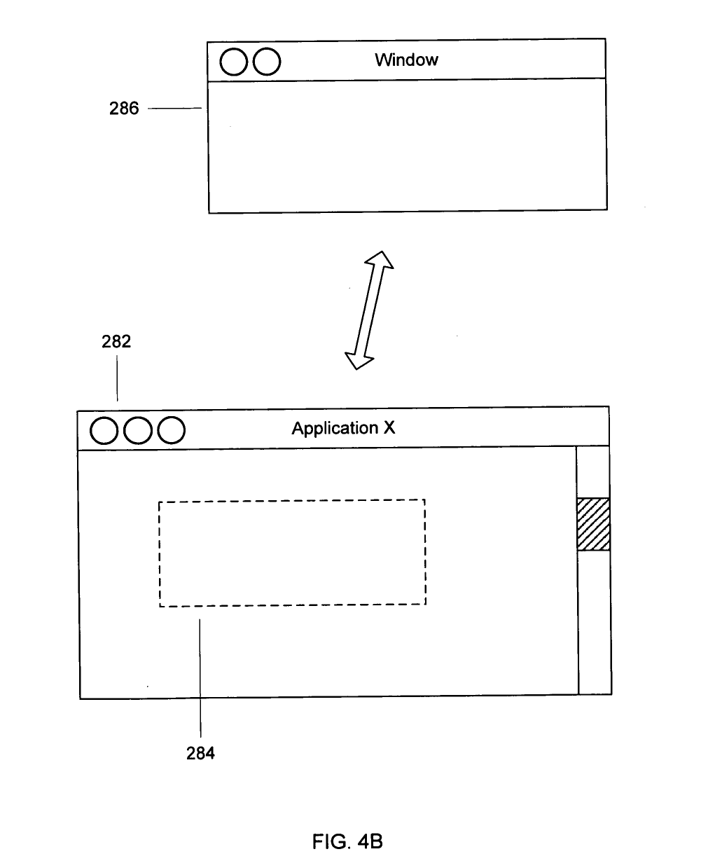

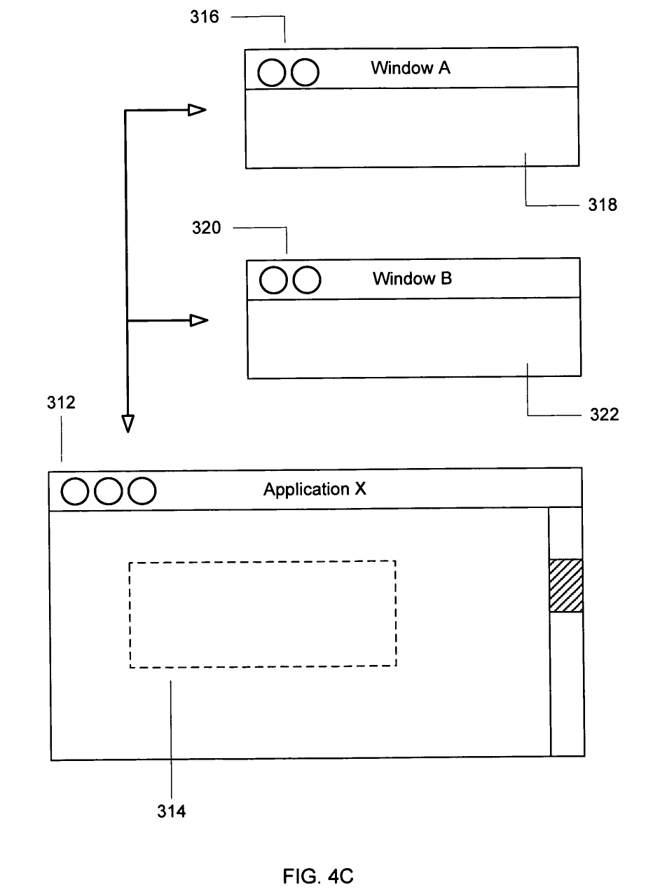

Now turning to FIGS. 4A-4C, various methods for presenting the transformed image are illustrated. Once a region is selected, and a desired transformation on the image in that region is performed, the transformed image is displayed in a region on a display screen. In some embodiments, the new image can be overlaid on top of the original image, as in magnifier applications. In some other embodiments, the new image may be displayed in a different part of the display screen. For example, the image can be displayed in a separate window on the desktop. It can also be displayed in a completely different display device. FIG. 4A shows an exemplary embodiment where a transformed image is displayed “in-place”. That is, the transformed image is displayed at the same location as that of the original image. (Neither image is actually shown in the figure.) In some embodiments, the size of the transformed image will be the same as the original one. In other embodiments, the sizes of these two corresponding images can be different. In this example, the original image contained partly in a region 254 of a window 252 will be hidden or semi-transparently obscured by the new image shown in the region 256. Note that the selection region is not shown in the figure because it is hidden below the new region 256.

Another method for displaying transformed images according to exemplary embodiments is illustrated in FIG. 4B. In this example, both the original and transformed images (not shown in the figure) are displayed on the screen, or on the desktop. The original image has been taken from a region 284 in a window 282. The transformed image can be displayed in a different region on the same screen of a display device or on different display devices. It can also be displayed in a separate window 286, as shown in this figure, whose position can be moved using the window manager functions provided by the system. In some embodiments, it can also be resized. This type of floating window is often called a HUD (heads up display) window. According to at least one embodiment of the present invention, the whole image in window 282, not just the image in the selected region 284, may be displayed in the second window 286. In such an embodiment, the transformation may still be limited to the image segment in the selected region.

FIG. 4C shows another method for displaying transformed images. This exemplary method is similar to the one shown in FIG. 4B. In this example, however, the transformed images are displayed in multiple regions. The figure shows three windows 312, 316, and 320 defining three regions 314, 318, and 322, all on one or more display devices. The output regions can also comprise an “in-place” region, overlapping the selected input region 314. Each output region can display the same or similar transformed image, possibly with different sizes or with different clippings or with different scale factors. In some embodiments, these images can be generated from different transformations.

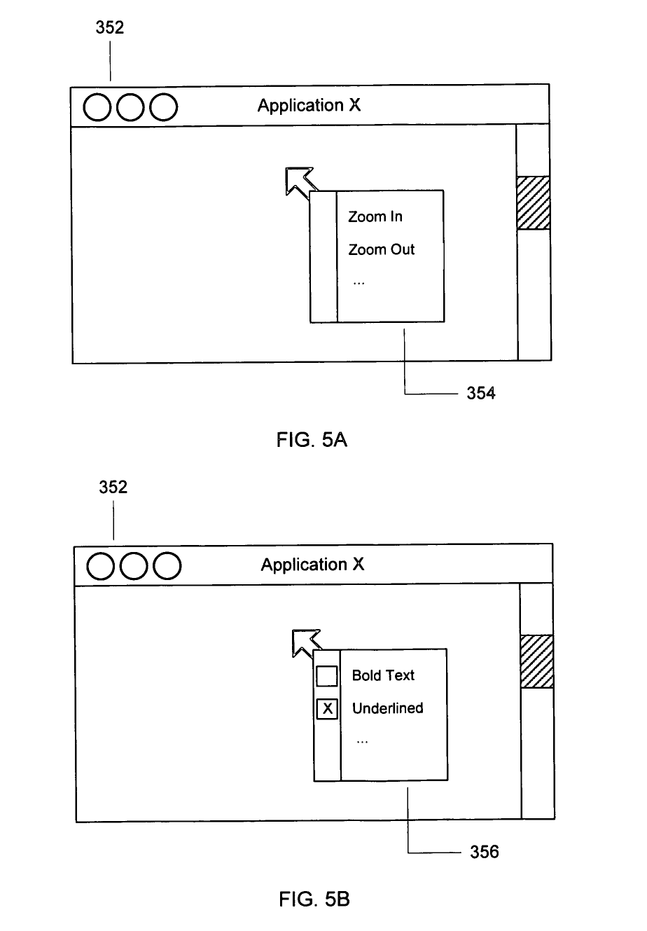

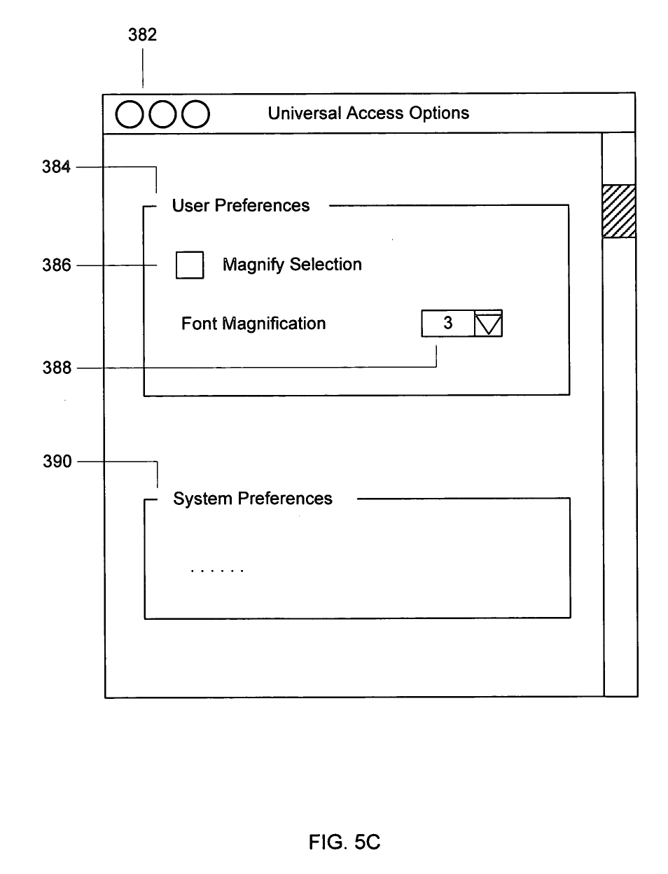

With respect now to FIGS. 5A-5C, exemplary methods for selecting desired transformations and for specifying related options are illustrated. Once a region is selected, for example using various methods shown in FIGS. 3A-3D, a desired transformation on the image in that region is specified. It can be done explicitly in response to user input, or it can be done implicitly based on system-wide or user-configured settings.

FIG. 5A shows a popup menu window 354, currently displayed on top of window 352. Popup menus are typically used to display context-sensitive, or context-dependent, menus in a graphical user interface. In this example, the menu includes commands for generating a second image in a preset region using a preset transformation, indicated by menu items “Zoom In” and “Zoom Out”. The popup menu window 356 of FIG. 5B, on the other hand, includes various options which will be used during the transformation. The menus may be associated with particular selected regions or they can be used to set system-level or user-level settings. The exemplary menu in window 356 of FIG. 5B includes some attributes usually associated with text strings, and it is shown on top of the application window 352. However, these drawings are for illustration purposes only, and these menus may not be associated with any particular applications or windows. For example, text strings selected from multiple windows, each of which is associated with a different application, can be simultaneously changed to bold style in some embodiments of the present invention.

FIG. 5C depicts an exemplary user interface for setting user preferences. These user preference settings can be used in conjunction with other means such as the popup menus, 354 and 356, shown in FIGS. 5A and 5B to customize various options associated with the transformation command. This preference setting can also be used for automatic transformation of images based on preset conditions, for example, for aiding visually impaired users. The exemplary window 382 of the figure is divided into two regions or panels, one 384 for the user-specific settings and the other 390 for global settings. The latter set of options may be displayed only to the users with special permissions. In this illustration, a couple of options are shown in the user preference panel. The checkbox “Magnify Selection” 386 may be used to automatically activate magnification or shrinkage features. The dropdown combobox 388 can be used to set a default font magnification level. In some embodiments, this value can be set independently of the overall magnification or zoom level that applies to the rest of the image.

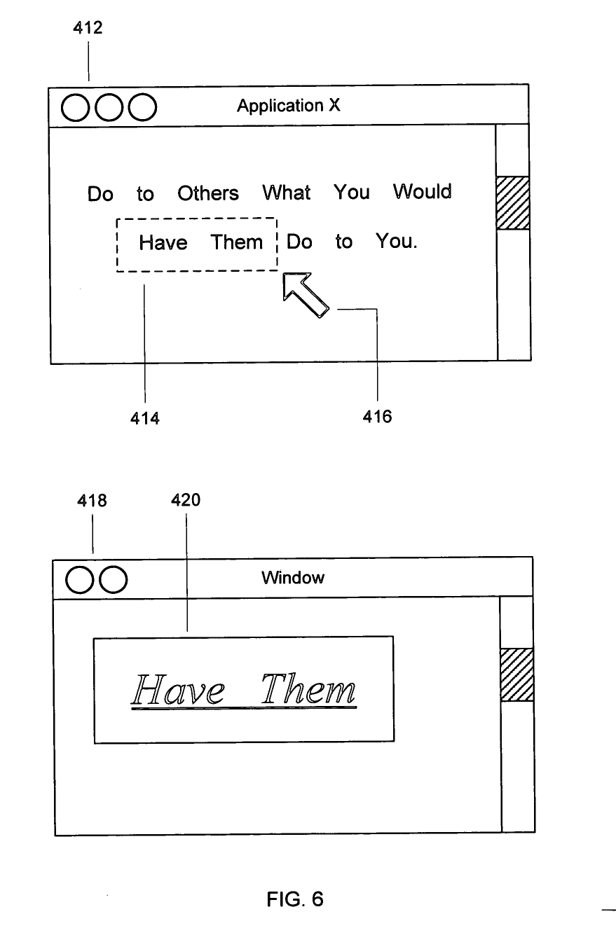

Once source and target regions are selected and a desired transformation is specified, either implicitly or explicitly, the next step is to perform the transformation. According to at least one embodiment of the present invention, this is done using the underlying data associated with the image in the selected region rather than pixel data of the image in a frame buffer. The data associated with an image can be divided into at least two types. One that has something to do with the presentation, or look or style, of the displayed image and another, called semantic data in this disclosure, that is inherent to the underlying objects and independent of any particular presentation. In some embodiments, the transformation is performed by modifying the presentation data associated with the image in the selected region. In other embodiments, this is done by generating a completely new image from the underlying semantic data. In yet other embodiments, the combination of these two modes are used. Some exemplary transformations according to embodiments of the present invention will now be illustrated with reference to FIGS. 6 through 9. In at least certain embodiments, the transformation on the underlying data is temporarily kept in the system and is discarded after the user deselects the object, and the underlying data (e.g. the selected text in a word processing file) is not changed in the stored copy of the underlying data on a non-volatile storage device (e.g. the text character codes, such as ASCII text codes, stored in the word processing file on the user's hard drive are not changed by the transformation).

FIG. 6 illustrates an exemplary transformation according to one embodiment. FIG. 6 shows a region 414 in a window 412 displaying a text string. The source region has been selected using a pointer 416 in this example. The transformed image is displayed in a region 420 in the second window 418, which may be on the same or a different display. In this illustration, some of the attributes of the text string have been changed in the transformation. For instance, the second image contains the text string in bold style with a different font (or font name), with a larger font size. It is also underlined. Other styles or attributes associated with a text string may, in general, be changed. For example, some of the common styles or attributes of a text string include the color of the text, the color of the background, the font weight (e.g. bold vs. normal), character spacing, and other styles/effects such as italicization, underlining, subscripting, striking through, etc. In this illustration of this particular embodiment, the image other than the text string (not shown in the figures) is not affected by the transformation. The pixel data for the text (e.g. pixel data in a frame buffer) is not used for the transformation; rather, the underlying data for the text string is used for the transformation. This is accomplished by retrieving the underlying data associated with the text string (e.g. ASCII character codes specifying the characters in the text string and metadata for the text string such as font type, font size, and other attributes of the text string) and applying the desired transformation only to that data without modifying the data associated with other objects in the image and without modifying the underlying data which specifies the text string in a stored copy of the file (e.g. the underlying character codes specifying the text in a word processing document which is stored as a file on a hard drive).

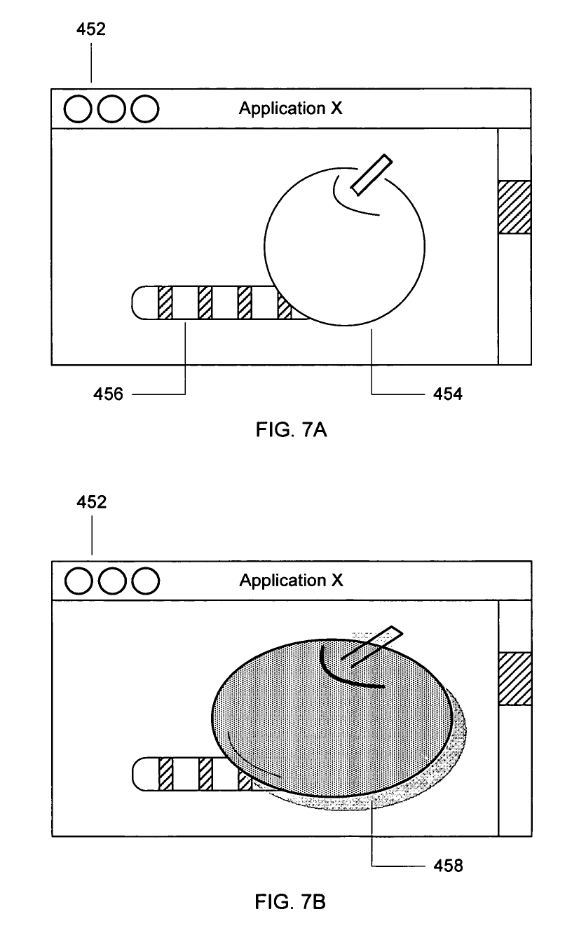

FIGS. 7A and 7B illustrate transformation of an object according to an embodiment of the present invention. In this example, an apple, 454 and 458, is shown in both figures with different renderings. FIG. 7A shows an original image including the apple 454, whereas FIG. 7B shows the transformed image with the apple 458 rendered slightly bigger. It is also drawn in different color. The magnified apple is displayed “in-place”. The two images are otherwise identical. That is, they are alternative representations of the same underlying semantic data, namely, an apple. Note how the background object 456 is obscured differently in these two figures. This is again accomplished, in some embodiments, by modifying the underlying data associated with the apple (and not the pixel data in a frame buffer which causes the display of the apple) but not others.

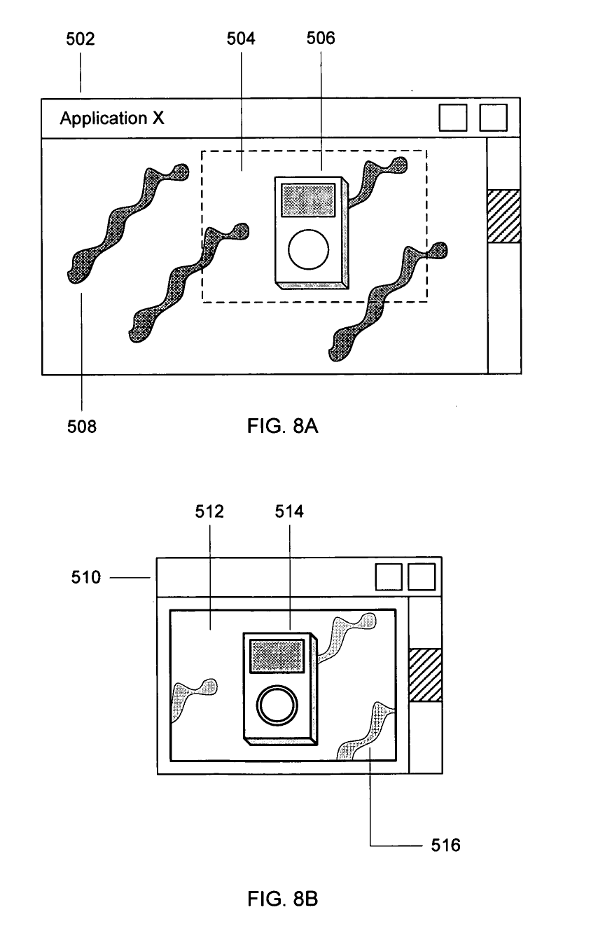

Another exemplary behavior according to an embodiment of the present invention is shown in FIGS. 8A and 8B. In this example, the original image shown in a window 502 of FIG. 8A includes objects, which are considered foreground. In particular, the foreground comprises an object 506, which is contained in a selection 504 indicated by broken lines. The rest of the image is considered background in this illustration. For example, wiggly shaped objects 508 are background objects. Note that the distinction between the foreground and background objects is not very clear in this rendering. After the transformation, however, the image shown inside a rectangular region 512 of window 510 in FIG. 8B has well-defined foreground objects which comprise the transformed object 514. The transformation has enhanced the foreground objects whereas it has essentially erased the background objects. In this illustration, the brightness of the wiggly objects 516 has been reduced. This feature essentially amounts to image processing on the fly, from the user's perspective. It should be noted, despite this particular illustration, that this type of image transformation is not limited to any specific window or application and it can be applied to any region on the desktop or the display.

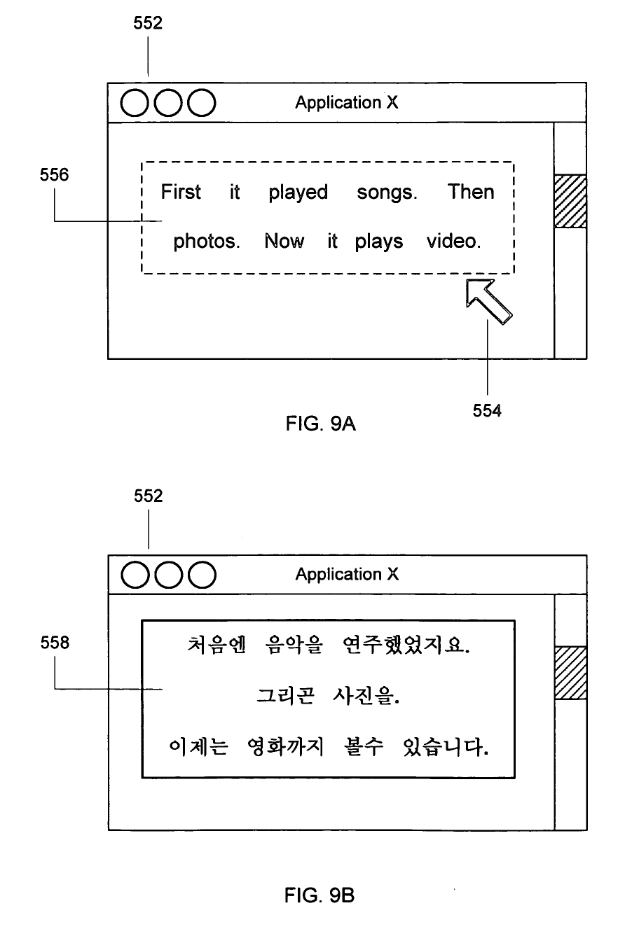

Referring to FIGS. 9A and 9B, another example based on an embodiment of the present invention is shown. The figures show a window 552 and two different images comprising text strings. In this example, the data associated with the image contains locale-specific information. For example, the string in a selected region 556 of FIG. 9A is English text, whereas the transformed image contains the same string, or content, this time written in the Korean language, and it is displayed in a region 558 in FIG. 9B overlaid on top of the source region 556 of FIG. 9A. In this example, the transformation amounts to generating a new image based on the semantic data associated with the selected objects. Note that the region 556 has been selected using a pointer 554 in FIG. 9A and the rest of the image is not shown in the figure for the sake of clarity. This particular example illustrates translation on the fly, which is again not limited to any one particular application. Other types of locale change can also be implemented, such as changing date or currency formats. Or, even paraphrasing a given sentence can also be implemented according to an embodiment of the present invention. For example, more verbose description for novice users of an application can be displayed, when requested, in place of, or in addition to, standard help messages.

Once a new image is generated based on the semantic transformation such as those shown in FIGS. 6 though 9, additional transformation may be applied to the generated image before it is rendered on the screen, or, transferred to the frame buffer. According to at least one embodiment of the present invention, a linear or non-linear scaling is performed to the semantically transformed image. For example, a fisheye transformation is applied to a magnified image to make it fit into a smaller region on the display. In some embodiments, simple clipping may be used.

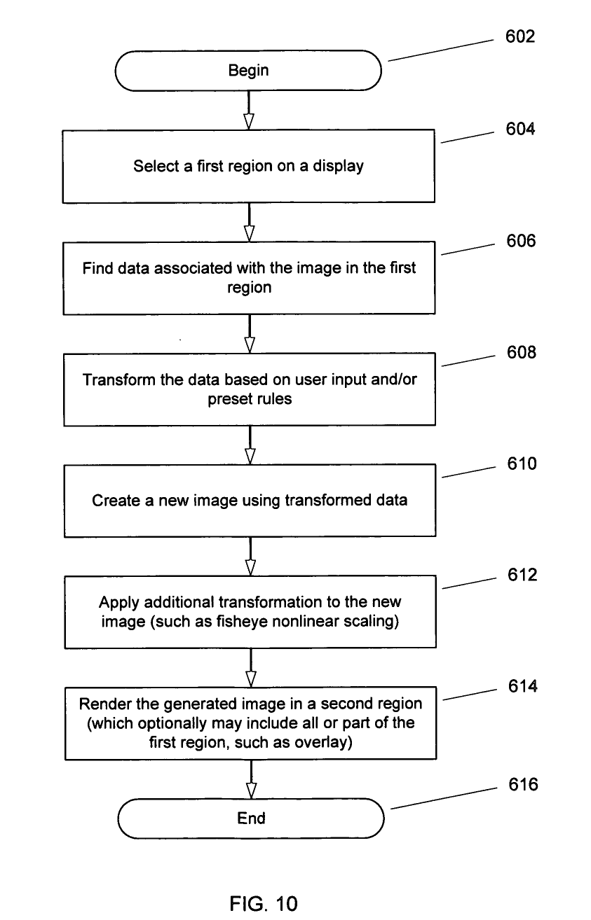

Turning now to FIGS. 10 through 12, flow charts illustrating various embodiments of the present invention are presented. FIG. 10 shows a method embodiment of the present invention. According to an exemplary process of this embodiment, defined between two blocks 602 and 616, an image in a region on a display is first selected, 604. Selection can be done, for example, using methods illustrated in FIG. 3. Or, the source region can be implicit. For instance, the entire desktop or the whole screen of a given display can be used as an implicitly selected region in some embodiments.

The image in a selected region is then used to retrieve the underlying data in the application or in the system, as shown in block 606. Next, the data is transformed based on the user request or other system settings 608, and a new image is generated 610. As explained earlier, the data associated with an image comprises at least two components: Semantic data and style or presentation data. In some embodiments, the transformation is performed by modifying the presentation data. In other embodiments, the transformation comprises generating a complete new image from the semantic data. In some embodiments, additional transformation such as linear or non-linear scaling or clipping is optionally applied to the semantically transformed image, at block 612. For example, a fisheye transformation may be used to make the image fit into a specified region. The transformed image is then rendered in the specified region on the display, as shown in block 614.

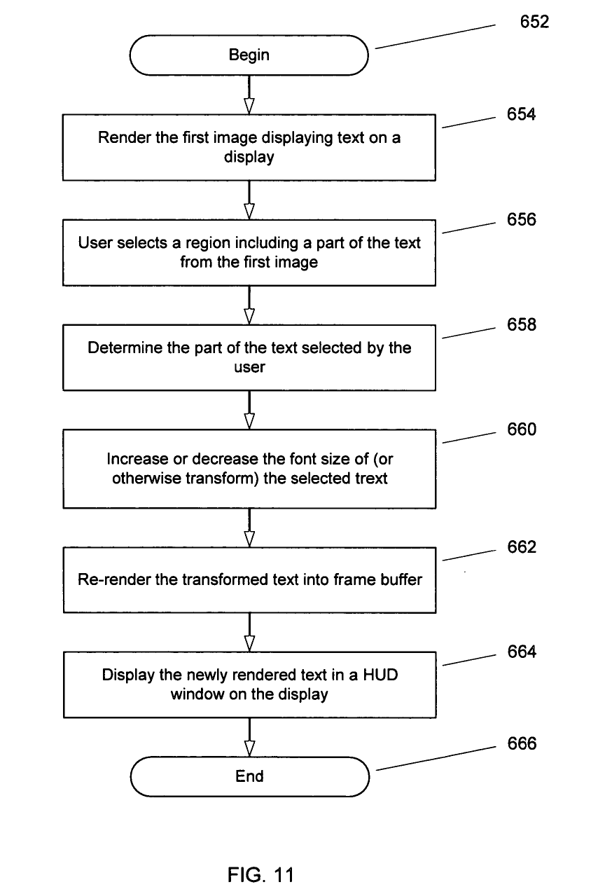

FIG. 11 illustrates an exemplary process according to another embodiment of the present invention. The process is defined between two blocks 652 and 666. In this example, text displayed on a screen, indicated by a block 654, is transformed according to the embodiment. At blocks 656 and 658, a region, and in particular a text string contained in the region, is first selected by a user, for instance, using a rubber-band UI of FIG. 3A. As stated earlier, selection might be done implicitly in some embodiments of the present invention. For example, a text string may beautomatically selected according to some preset criteria, which may be based on user requests, application logic, or system-wide settings. Next, the selected text string is transformed based on preset rules or based on the user input. As shown in block 660, the transformation comprises changing font size of the selected text, as in the prior art magnifier application. Or, its style or color can be changed. In some embodiments, the transformation comprises paraphrasing the text, as in the example shown in FIG. 9. Then, the transformed text string is re-displayed, in this example, in a separate window, as indicated by blocks 662 and 664.

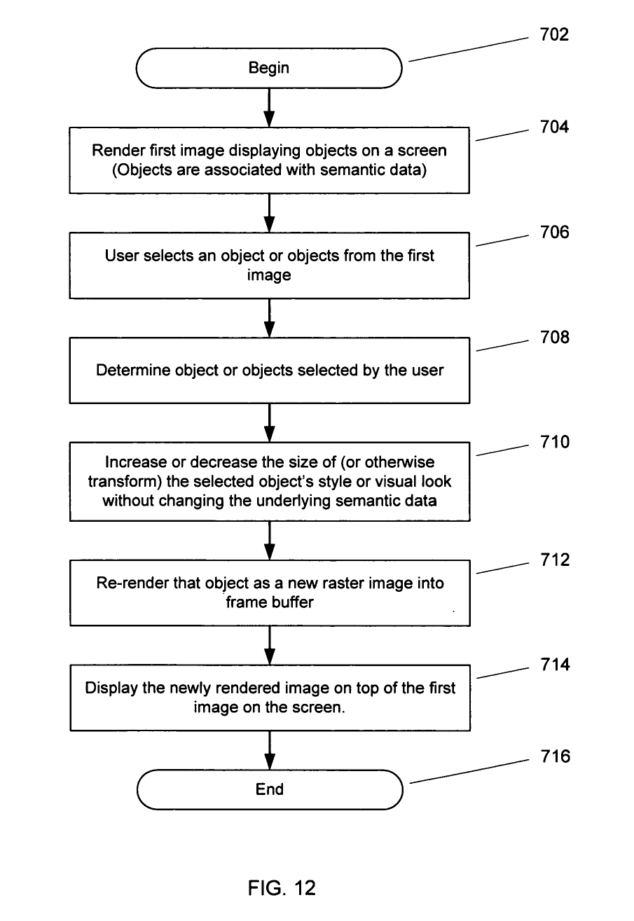

Another exemplary process is illustrated in FIG. 12 beginning with a block 702. In this example, at least one object is first selected by a user, at blocks 704 and 706, for instance, using a method shown in FIG. 3B. The objects are associated with semantic data, which is typically stored in, or managed by, an application responsible for rendering of the objects. However, in some embodiments of the present invention, this data is exposed to other applications or systems through well-defined application programming interfaces (APIs). Then the application or the system implementing the image transformation retrieves the data associated with the selected objects, at block 708, and applies the predefined transformation to the data to generate a new image, at block 710. For example, visual looks and styles of the selected objects may be modified according to various methods shown in FIGS. 6 through 9. Then, the transformed object is re-displayed “in-place”, at blocks 712 and 714. This exemplary process terminates at 716.

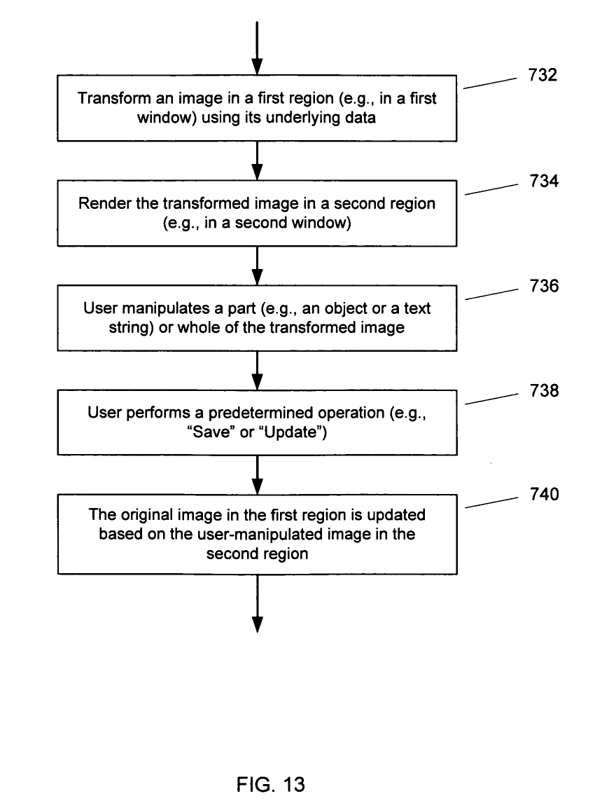

In certain embodiments of the present invention, the transformed image may be further manipulated by the user. For example, the user might (further) enlarge the font size of the (already enlarged) text. Or, the user might even edit the text or modify the transformed image. In some embodiments, the original image may be updated based on this additional change in the second region, either automatically or based on a user action such as pressing an “update” button. In some cases, the underlying data may be updated according to the change in the transformed image in the second region, either automatically or based on an additional action. This is illustrated in a flow chart shown in FIG. 13. According to this exemplary process, the image in a first region is transformed 732 and rendered 734 on a second region, which may or may not be in the same window as the first region. Then the user manipulates the image, at block 736. For example, the user may change the text color, or he or she may “pan” around or even be able to select a region or an object in the second window. In applications such as word processors, the user may be able to edit the (transformed) text displayed in the second region just as he or she would with the (original) text in the first region. In some embodiments, this change or modification may be automatically reflected in the original image in the first region, 740. In some other embodiments, an explicit user action such as “Refresh”, “Update”, or “Save” might be needed, as indicated by an operation 738 in the flow chart of FIG. 13. In certain embodiments, or in certain applications, the underlying data may also be modified based on the change in the second image, again either automatically or based on an explicit action or an event triggered by a preset criterion.

The present invention can be embodied as a stand-alone application or as a part of an operating system. Typical embodiments of the present invention will generally be implemented at a system level. That is, they will work across application boundaries and they will be able to transform images in a region currently displayed on a display screen regardless of which application is responsible for generating the original source images. According to at least one embodiment of the present invention, this is accomplished by exposing various attributes of underlying data through standardized APIs. In some cases, existing APIs such as universal accessibility framework APIs of Macintosh operating system may be used for this purpose.

In cases where a selected region contains an image generated by an application which is not completely conformant with the transformation API used in a particular operating system, part of the image in the region may be transformed based on the displayed raster image, or its frame buffer equivalents, according to some embodiments of the present invention. In some cases, accessing the underlying data of some applications might require special access permissions. In some embodiments, the transformation utility program may run at an operating-system level with special privilege.

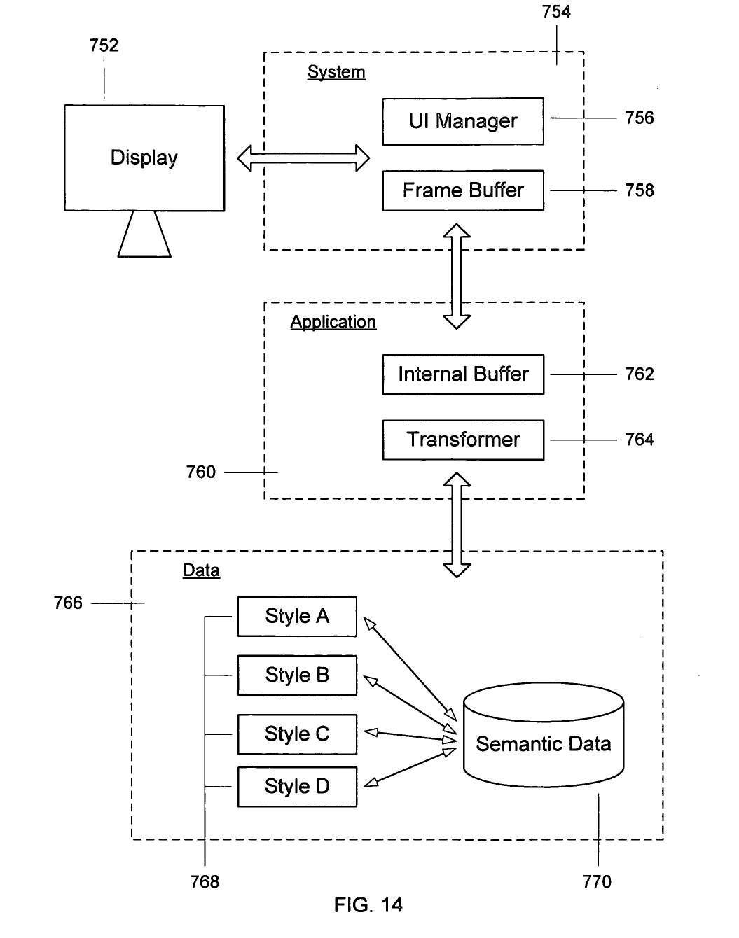

With respect now to FIG. 14, one exemplary design of an embodiment of the present invention is illustrated. The figure shows an operating system 754 and a participating application 760. The system 754 comprises a UI manager 756 and a frame buffer 758. The application 760 comprises internal data structure 762 and a transformer module 764. Portion of the image displayed on a display screen 752 is based on the memory content of the frame buffer 758 and it is originally generated by the application 760. The system manages the UI and display functionalities, and it communicates with the application through various means including the frame buffer 758. Various modules shown in the figure should be regarded as functional units divided in a logical sense rather than in a physical sense. Note that some components refer to hardware components whereas other components refer to software modules. According to this embodiment, the data 766 comprises the semantic part 770 and the style or presentation part 768. For example, for a text string stored in a user's word processing document which is saved as a file on a non-volatile storage device such as a hard drive, the semantic part may be ASCII or Unicode character codes which specify the characters of the text string and the style part may be the font and font size and style. The styles can be pre-stored or dynamically generated by the transformer module 764. It should be noted that the transformer is included in the participating application in this embodiment rather than, or in addition to, being implemented in a transformer utility program. This type of application may return transformed images based on requests rather than the underlying semantic data itself. In some embodiments, this functionality is exposed through public APIs.

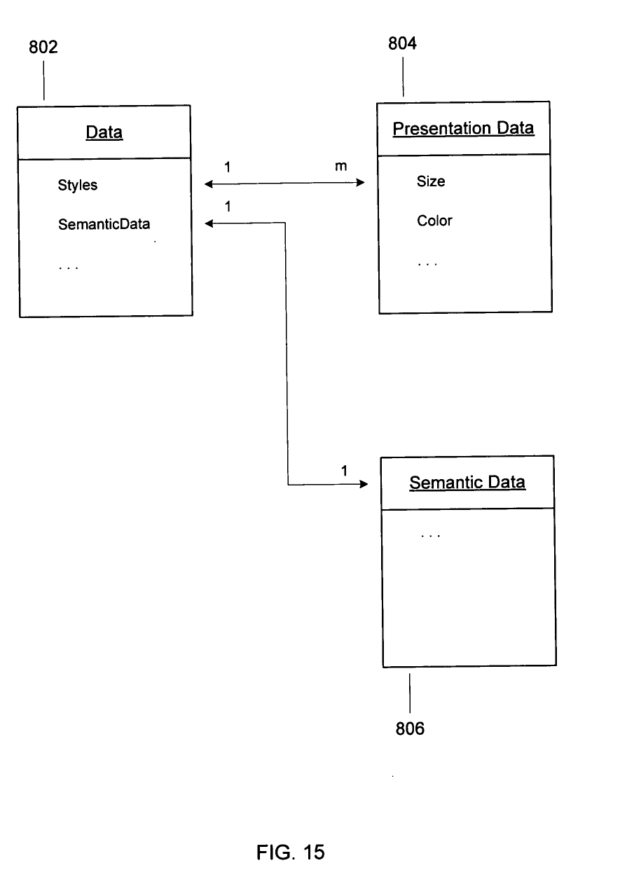

FIG. 15 shows various data structures used in a software embodiment of the present invention. In particular, it shows UML class diagrams of various internal data structures used to represent data. These class diagrams are included in this disclosure for illustrative purposes only. The present invention is not limited to any particular implementations. According to this design, a class representing data 802 of an object or an idea uses at least two different classes, one for the semantic data 806 and another for presentation 804. Note that each data associated with an object or idea may be associated with one or more presentation data. The semantic data will typically be specific to the object or the idea that it is associated with, and its elements, or attributes and operations, are simply marked with ellipsis in the figure. In some embodiments, more concrete classes may be used as subclasses of the Semantic_Data class 806.

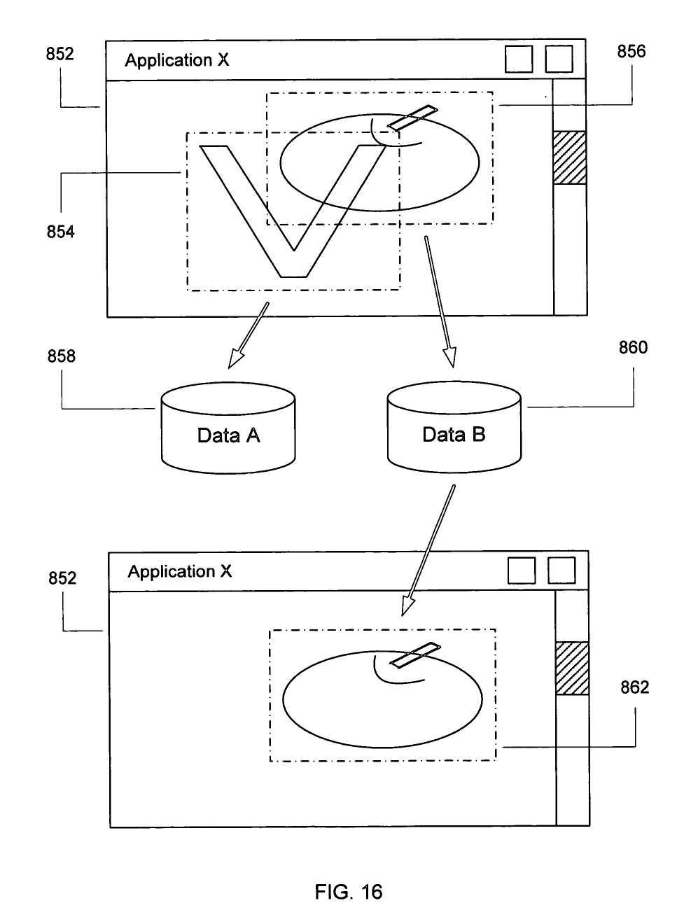

With reference to FIG. 16, it illustrates an exemplary semantic transformation of an image according to an embodiment of the present invention. The figure shows two overlapping image objects, 854 and 856, displayed in a window 852 and their corresponding internal data structures, 858 and 860, respectively. In this example, even though the two images are overlapping on the display, the transformer module can easily select one or the other, and it can display the selected image only. Or, it can apply any desired transformations to the selected data only. In this particular example, the image 856 generated from data B, 860, is selected and it has been transformed into a different image 862 and displayed overlaid on top of the original image, as shown in the bottom window. The other image segment 854 associated with data A, 858, has been removed in this particular example.

As will be appreciated by one of skill in the art, the present invention may be embodied as a method, data processing system or program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the medium. Any suitable storage medium may be utilized including hard disks, CD-ROMs, DVD-ROMs, optical storage devices, or magnetic storage devices. Thus the scope of the invention should be determined by the appended claims and their legal equivalents, and not by the examples given.

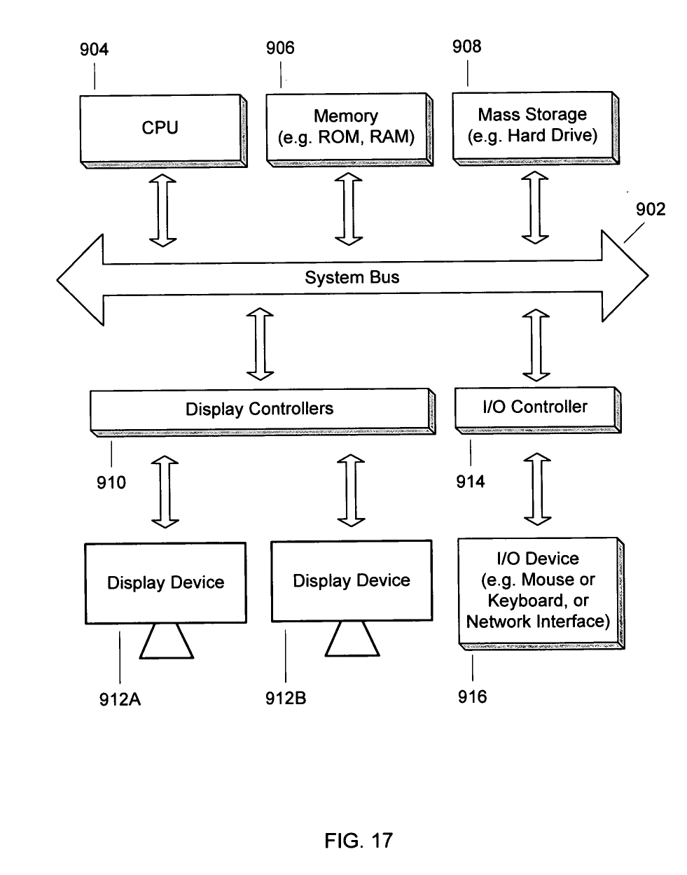

FIG. 17 shows one example of a typical data processing system which may be used with embodiments of the present invention. Note that while FIG. 17 illustrates various components of a data processing system, it is not intended to represent any particular architecture or manner of interconnecting the components as such details are not germane to the present invention. It will also be appreciated that network computers and other data processing systems (such as cellular telephones, personal digital assistants, music players, etc.) which have fewer components or perhaps more components may also be used with the present invention. The computer system of FIG. 17 may, for example, be a Macintosh® computer from Apple Computer, Inc.

As shown in FIG. 17, the computer system, which is a form of a data processing system, includes a bus 902 which is coupled to a microprocessor(s) 904 and a memory 906 such as a ROM (read only memory) and a volatile RAM and a non-volatile storage device(s) 908. The CPU 904 may be a G3 or G4 microprocessors from Motorola, Inc. or one or more G5 microprocessors from IBM. The system bus 902 interconnects these various components together and also interconnects these components 904, 906, and 908 to a display controller(s) 912 and display devices 914A and 914B and to peripheral devices such as input/output (I/O) devices 916 which may be mice, keyboards, modems, network interfaces, printers and other devices which are well known in the art. Typically, the I/O devices 916 are coupled to the system through I/O controllers 914. The volatile RAM (random access memory) 906 is typically implemented as dynamic RAM (DRAM) which requires power continually in order to refresh or maintain the data in the memory. The mass storage 908 is typically a magnetic hard drive or a magnetic optical drive or an optical drive or a DVD ROM or other types of memory system which maintain data (e.g. large amounts of data) even after power is removed from the system. Typically, the mass storage 908 will also be a random access memory although this is not required. While FIG. 17 shows that the mass storage 908 is a local device coupled directly to the rest of the components in the data processing system, it will be appreciated that the present invention may utilize a non-volatile memory which is remote from the system, such as a network storage device which is coupled to the data processing system through a network interface 916 such as a modem or Ethernet interface. The bus 902 may include one or more buses connected to each other through various bridges, controllers and/or adapters as is well known in the art. In one embodiment, the I/O controller 914 includes a USB (universal serial bus) adapter for controlling USB peripherals and an IEEE 1394 (i.e., “firewire”) controller for IEEE 1394 compliant peripherals. The display controllers 910 may include additional processors such as GPUs (graphical processing units) and they may control one or more display devices 912A and 912B. The display controller 910 may have its own on-board memory, which can be used, among other things, for frame buffers.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as ROM or RAM 906, mass storage, 908 or a remote storage device. In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software codes to simplify the description. However, those skilled in the art will recognize what is meant by such expressions is that the functions result from execution of the code by a processor, such as the CPU unit 904.

What is claimed is:

1. A method to display an image on a display, said method comprising:
selecting a first region on the display, wherein a first image displayed in said first region is generated based on semantic data;
performing a transformation of said first image to generate a second image, wherein said transformation is done by generating said second image from said semantic data; and
displaying said second image in a second region on the display.

2. The method of claim 1, wherein:
said selecting comprises one of:
(a) selecting said first region using a pointing device;
(b) selecting said first region from a set of at least one preset region; and
(c) selecting said first region without user input.

3. The method of claim 1, wherein:
said first region comprises one of:
(a) a rectangular region on the display; and
(b) a region on the display associated with a subset of said semantic data representing at least one of an object and an idea.

4. The method of claim 1, wherein:
said semantic data comprises data associated with at least one text string displayed on said first display, said at least one text string having at least one attribute;

5. The method of claim 4, wherein:
said at least one attribute comprises a font of said at least one text string; and
said transformation comprises changing at least one of:
(a) said font;
(b) size of said font;
(c) color of said font; and
(d) style of said font.

6. The method of claim 4, wherein:
said transformation comprises paraphrasing said at least one text string.

7. The method of claim 1, wherein:
said transformation comprises changing at least one image property of a sub-region in said first region.

8. The method of claim 7, wherein:
said at least one image property comprises one of:
(a) a brightness;
(b) a color;
(c) a transparency; and
(d) a size.

9. The method of claim 7, wherein:
said transformation comprises changing first at least one image property of a first sub-region in said first region with a first value and changing second at least one image property of a second sub-region in said first region with a second value, said first sub-region being distinct from said second sub-region, wherein said first value is different from said second value.

10. The method of claim 1, further comprising:
applying non-linear scaling to said second image.

11. The method of claim 10, wherein:
said non-linear scaling comprises a fisheye transformation.

12. The method of claim 1, wherein:
said transformation is done based on one of:
(a) user input; and
(b) at least one preset value

13. The method of claim 1, wherein:
said second region is different from said first region.

14. The method of claim 1, further comprising:
updating said first image in response to a change in said second image.

15. A method to transform an image on a display, said method comprising:
selecting a first region on the display, wherein a first image displayed in said first region is based on first data, said first data comprising second data and third data;
performing a transformation of said first image to generate a second image, wherein said second image is generated from said first image by transforming said second data; and
displaying said second image in a second region on the display.

16. The method of claim 15, wherein:
said selecting comprises one of:
(a) selecting said first region using a pointing device;
(b) selecting said first region from a set of at least one preset region; and
(c) selecting said first region without user input.

17. The method of claim 15, wherein:
said first region comprises one of:
(a) a rectangular region on the display; and
(b) a region on the display associated with a subset of said semantic data representing at least one of an object and an idea.

18. The method of claim 15, wherein:
said second data comprises data associated with at least one text string displayed on said first display, said at least one text string having at least one attribute;
said at least one attribute comprises a font of said at least one text string; and
said transformation comprises changing at least one of:
(a) said font;
(b) size of said font;
(c) color of said font; and
(d) style of said font.

19. The method of claim 15, wherein:
said transformation comprises changing at least one image property of a sub-region in said first region; and
said at least one image property comprises one of:
(a) a brightness;
(b) a color;
(c) a transparency; and
(d) a size.

20. The method of claim 15, further comprising:
applying non-linear scaling to said second image.

21. The method of claim 20, wherein:
said non-linear scaling comprises a fisheye transformation.

22. The method of claim 15, further comprising:
updating said first image in response to a change in said second image.

23. A machine readable medium containing executable computer program instructions which, when executed by a digital processing system, cause said system to perform a method, the method comprising:
selecting a first region on a display, wherein a first image displayed in said first region is generated based on semantic data;
performing a transformation of said first image to generate a second image, wherein said transformation is done by generating said second image from said semantic data; and
displaying said second image in a second region on the display.

24. The machine readable medium of claim 23, wherein:
said selecting comprises selecting said first region based on user input.

25. The machine readable medium of claim 23, wherein:
said first region comprises one of:
(a) a rectangular region; and
(b) a region on said first display associated with a subset of said semantic data representing at least one of an object and an idea.

26. The machine readable medium of claim 23, wherein:
said semantic data comprises data associated with at least one text string displayed on said first display, said at least one text string having at least one attribute;

27. The machine readable medium of claim 26, wherein:
said at least one attribute comprises a font of said at least one text string; and
said transformation comprises changing at least one of:
(a) said font;
(b) size of said font;
(c) color of said font; and
(d) style of said font.

28. The machine readable medium of claim 26, wherein:
said transformation comprises paraphrasing said at least one text string.

29. The machine readable medium of claim 23, wherein:
said transformation comprises changing at least one image property of a sub-region in said first region.

30. The machine readable medium of claim 23, wherein:
said transformation is done based on one of:
(a) user input; and
(b) at least one preset value.

31. The machine readable medium of claim 23, wherein the method further comprising:
updating said first image in response to a change in said second image.

32. A data processing system, the system comprising:
a processor coupled to a display device; and
a memory coupled to said processor, said memory having instructions configured to select a first region on said display device, wherein a first image displayed in said first region is generated based on semantic data; and said memory having instructions configured to perform a transformation of said first image to generate a second image, wherein said transformation is done by generating said second image from said semantic data; and wherein said second image is displayed in a second region on said display.

33. The data processing system of claim 32, wherein:
said semantic data comprises data associated with at least one text string displayed on said at least one display, said at least one text string having at least one attribute;

34. The data processing system of claim 33, wherein:
said at least one attribute comprises a font of said at least one text string; and
said transformation comprises changing at least one of:
(a) said font;
(b) size of said font;
(c) color of said font; and
(d) style of said font.

35. The data processing system of claim 32, wherein:
said transformation comprises changing at least one image property of a sub-region in said first region.

36. The data processing system of claim 32, further comprising:
an input device.

37. The data processing system of claim 36, wherein:
said selecting comprises selecting said first region based on input from said input device.

38. The data processing system of claim 36, wherein:
said transformation is done in response to input from said input device.
